(19) United States
(12) Patent Application Publication
(10) Pub. No.: US 2008/0172299 A1
(43) Pub. Date: Jul. 17, 2008

(54) Health reminders provided by product and service entities

(76) Inventor: Ronald John Rosenberger, Newtown, PA (US)

Correspondence Address: Ronald John Rosenberger, 506 Sterling Street, Newtown, PA, 18940, US

(21) Appl. No.: 12/075,260

(22) Filed: Mar. 10, 2008

Related U.S. Application Data
(63) Continuation-in-part of application No. 09/634,612, filed on Aug. 5, 2000, now abandoned.

(51) Int. Cl. G06Q 30/00; G06Q 99/00

(52) U.S. Cl. 705/14; 705/1

(57) ABSTRACT

The present methods and systems of this invention provide health reminder or health awareness tools to individual end users that are not specific to the product or service being provided by the entity that is providing the health reminder, wherein such methods can also include where advertisements for products and services are provided with such health reminders as an additional service to the end user that may be appreciated by the end user in order to identify the benefits of such health reminders with the goodwill of such product or service providers and which may result in increased use or purchase of such unrelated products or services that are associated with such entities or companies providing the health reminders as a beneficial free service of the product or service provider entity.

### CROSS REFERENCE TO RELATED APPLICATIONS

This application is a continuation-in-part of USPTO non-provisional application Ser. No. 09/634,612, filed Aug. 5, 2000, which is entirely incorporated herein by reference. This application claims benefit from provisional application 60/394,143, filed Jul. 6, 2002, and provisional application 60/394,402, filed Jul. 8, 2002, which are each entirely incorporated herein by reference.

### BACKGROUND OF THE INVENTION

In some cases, individual end users may receive health reminders related to particular health services provided by medical entities such as medical information management systems or health care providers related to specific conditions or diseases for which such medical entity is providing particular services. For example, Sun et al (US 2002/0022973) teaches a medical information management system and patient interface appliance to receive and manage medical information associated with patients; and Byerly et al (U.S. Pat. No. 6,067,524) teaches a method for generating advisory messages to pharmacy patients that relate to particular or specific prescriptions that are being filled by the pharmacy, which notices or reminders indicate proper usage and management of conditions for which the prescription drug being purchased or provided to the patient.

### SUMMARY OF THE INVENTION

The present methods and systems of this invention provide health reminder or health awareness tools to individual end users that are not specific to the product or service being provided by the entity that is providing the health reminder. Such methods can also include where advertisements for products and services are provided, where an end user becomes more receptive to such advertising due to the goodwill generated by the product or service providing entities also providing the health reminders, which may result in increased use or purchase of such health-reminder-unrelated products or services that are associated with such entities or companies providing the health reminders as a beneficial service of the product or service provider entity. In particular, halo effect, or similar goodwill, can be generated for such product or service providers by providing health reminders that benefit the end user, but which are not related to the particular products or service provided. In turn the benefit to the end user helps the company to gain goodwill with end user such that the end user may be more likely to use such product or service provider for purchasing such products or services whether the end user is a current or potential end user of such products or services. Such health reminders thus can be associated with such product or service providers, optionally provided with advertisements for such products or services, to generate goodwill which could in turn result in the purchase of products and services by the end user from such product or service providers, even where the health reminder does not specifically relate to a particular product or service provided by company or organization providing the health reminder. The health awareness tools can comprise one or more of reminders, tips or suggestions for any health-related topic, health-related preventive measure, medical check-up, medical exam, or medical procedure. The reminder, tips, or suggestions may pertain to males and/or females of any age range, and may even include the end user's pets.

Non-limiting examples include mammogram or other medical test reminders, or information, including tips and suggestions regarding same; prostate exam reminders, dental exam reminders, and even milestone reminders that kick in automatically at certain ages, such as colorectal exam reminders starting at the age of fifty. Tips or suggestions may accompany a reminder; for example, a breast self-exam reminder may come with a tip or suggestion on what time of the month is best to perform the exam. Also, it is foreseeable that tips or suggestions may be included in absence of an actual reminder. Other kinds of health related tools in addition to reminders, tips, or suggestions will be discussed later.

The method provides health reminders to individual end users of “typical”, non-medical customer services. The health reminder comprises one or more reminder, tip or suggestion for any health-related topic, health-related preventive measure, medical check-up, medical examination, or medical procedure. In this disclosure, the health reminder acts as an all important health awareness tool for end users where the health reminder comprises at least one health related reminder, tip, or suggestion for end users, and where the health awareness tool encourages end users to take self-initiative or self-action to heed the health-related preventive measure, to schedule medical check-up, medical examination, or medical procedure. It should be important to note that the health reminder, in its function as a health awareness tool, is not used to remind said end users of a preexisting or already scheduled doctor appointment, but is rather used to raise health awareness and to encourage end users to self-schedule medical check-up, medical examination, and/or medical procedure in absence of any direct prompting from doctors or health care professionals responsible for the medical care of the end users.

The health reminder may pertain to male and/or female end users of any age range, and/or individuals related to or otherwise associated with the end users, such as spouses (for a husband's prostate examination), children (for child immunizations) or possibly even end users' pets. Examples of health reminders include mammogram reminders, including tips and suggestions regarding same; prostate exam reminders, dental exam reminders, and even milestone reminders that kick in automatically at certain ages, such as colorectal exam reminders starting at the age of fifty. Tips or suggestions may accompany a reminder; for example, a breast self-exam reminder may come with a tip or suggestion on what time of the month is best to perform the exam. Also, it is possible that tips or suggestions may be presented in absence of an actual reminder. In this disclosure, the importance of the health reminder as a health awareness tool cannot be understated. Saving lives through providing such a health awareness tool is a primary goal and intent of this disclosure.

The health reminder comprising health related reminders, tips, or suggestions may additionally comprise non-health reminders, tips, or suggestions. Such non-health reminders, tips, or suggestions can include any kind of reminders, tips, or suggestions, such as birthday reminders, anniversary reminders, other event reminders, car care reminders with tips or suggestions, etc. It should be noted that non-health reminders are offered as an added convenience and are distantly secondary to the health reminder's primary purpose and importance as a health awareness tool, and that non-health reminders by themselves serve absolutely no contributory function whatsoever as health awareness tools that may potentially save lives.

Customer services accounts or activities that may be enhanced through the implementation of a health reminder as a customer service function include the following:

Any financial services account that tends to not make ancillary use of a financial card, such as checking accounts or savings accounts that do not make use of a debit card, investment brokerage accounts, money market accounts, certificate of deposit accounts, etc. Such accounts generate account activity and as a result may make use of any customer services communications pertinent to such accounts, such as activity statements, transaction confirmations, special notices, etc. These customer services communications may or may not also comprise advertisements. Such financial services accounts do not comprise any primary function relating to the health care of end users. A checking account, for example, may be used to pay for a doctor bill, but the old and well-known primary function of a checking account is to make payments in general, and not to pay medical bills primarily or exclusively. Enhancing customer services for any such financial services account with a health reminder function would certainly be outside the realm of financial customer services.

Any financial services account that tends to not make ancillary use of a financial card, but requires debt servicing, such as a loan account, first or second home mortgage, etc. Such accounts generate account activity and as a result may make use of any customer services communications pertinent to such accounts, such as statements of activity, billing statements, special notices, etc. These customer services communications may or may not also comprise advertisements. Such financial services accounts do not comprise any primary function relating to the health care of end users. Enhancing customer services for these types of accounts with a health reminder function would also be outside the realm of financial customer services normally associated with these accounts.

Any products or services whose consumption by end users comprises accounts, that uses, or may be adapted to use, a sign up or application process, where the products or services serve no primary function or functions relating to the health care of individuals, or where the entity ordinarily serves no function regarding the dissemination of health information to specific individuals. This is admittedly very broad, and may include entities offering products or services such as bottled water, telephone service, cable television service, garbage removal, etc. These accounts generate account activity and as a result may make use of any customer services communications pertinent to such accounts, such as statements of activity, usage summaries, billing statements, transaction receipts, special notices, etc. These customer services communications may or may not also comprise advertisements. As mentioned in the prior cases, enhancing customer services for these types of non-medical accounts with a health reminder function would be outside the realm of customer services for these products or services.

Combining advertisements with a health reminder makes for an interesting situation that may increase the efficacy of the advertisements being sent. By combining the offering of advertisements with a health reminder, the end users that request the health reminder are making a defacto request to receive advertisements. Normally, end users tend only to actually request advertisements by signing up on mailing lists; otherwise, advertisements are basically forced on the end user, whether the end user likes it or not. By combining the offering of the health reminder with advertisements, it is likely that the end user will be more receptive to the advertisements as a “tit for tat” for receiving the health reminder. Also, there is a likelihood that end users could consider the entities offering health reminders/advertisements as being caring and concerned for the health and well-being of individuals as a result of offering potentially life saving health prevention tools, resulting in positive image enhancement and “halo effect” to the offering entity. Such an enhancement to traditional advertising may serve to help the reminders/advertisements stand out in a world that is full of “ad clutter”, and may result in new customers, and/or more loyal customers for the offering entity. A promotional entity willing to expend the extra effort and expense by offering health reminders to end users in addition to its advertisements could very well obtain a captive audience for its advertising.

There are several ways to consider the kinds of advertisements that may be used. The first is entity promotion, where the advertisements focus on the entity rather than a specific product or service. The second is where the advertisements focus on products or services. This covers much ground, with examples comprising such forms as product promotion, services promotion, sales event promotion, special offers promotion, coupons, special programs, or information dissemination.

Let's look at the abovementioned forms of promotion in terms of automobiles, although the teachings of the disclosure may be applied to any product or service. Entity promotion may simply comprise of the name of the car manufacturer, such as “These health awareness tools are provided by the ABC Automobile Company”. The offering of the health awareness tools is intended to encourage a positive attitude or viewpoint about the offering entity outside of the actual products or services that the entity offers. Including other bits of information in addition to the name of the entity could enhance the positive attitude or viewpoint. Such examples comprise “These health awareness tools are provided by the ABC Automobile Company, who reminds you that February is Black History Month”, or “These health awareness tools are provided by the ABC Automobile Company, proud sponsor of the Canine Olympics and Breast Cancer Research”. In these examples, the company can be viewed as informative (reminding individuals about Black History Month, which also acts to acknowledge a particular demographic), or supportive (showing that the company supports meaningful events such as the Canine Olympics and meaningful causes such as Breast Cancer Research). Here, current or potential customers aren't encouraged to buy anything in particular, but are possibly induced into thinking kindly and warmly about an offering entity that is willing to go to the trouble of offering health reminders and is perhaps also able to demonstrate additional noble characteristics. Such courting of goodwill may provide the offering entity with an advantage over the competition if or when the occasion to transact business arises.

Product and services promotion comprises the mention of non-medical products or services, such as “These health reminders are provided by the ABC Automobile Company, who invites you to test drive the revolutionary DEF and GHI automobiles,” or “These health reminders are provided by the ABC Automobile Company, who invites you to take advantage of the world-class repair facilities at our world-class dealerships”, and may instead or additionally comprise advertisements in the form of product catalogs, service brochures, or other promotional literature. Sales event promotion comprises the mention of sales events, such as “These health reminders are provided by the ABC Automobile Company. Our dealers have slashed prices, so be sure to take advantage of our special year-end liquidation”. Special offers promotion comprises “Mention that you receive our health reminders, and the dealer will take an additional $1000 off your best deal”, a rebate offer on brake pads, or a contest or giveaway awarding a new car. Coupon promotion comprises, for example, a coupon for an oil change, or a discount coupon on a vehicle. Special programs comprise where end users sign up for a special car care benefit that comprises year round maintenance discounts, where the advertisements comprise promotion of, or any communications concerning, special programs. Finally, is where advertising comprises information dissemination, such as newsletters comprising information and articles about car care. Information dissemination not related to automobiles may comprise any topic, such as recipes, dog-grooming information, and other general information that is not specific to a particular end user. It is conceivable that advertisement offerings may comprise any of the above forms of promotion alone, or in any combination or permutation comprising the multiple mentioned forms of promotion.

Advertisements combined with health reminders are a perfect fit for direct-to-consumer advertisements for specific products and/or services of a pharmaceutical company. Pharmaceutical companies that develop, produce, and market drugs spend fortunes on direct-to-consumer advertising. The goal with direct-to-consumer advertising is where the advertising entity asks a potential end user to “ask your doctor about” the promoted drug, which anecdotally is a strategy that works extraordinarily well. Offering health reminders along with pharmaceutical direct-to-consumer advertising for any specific products and services comprises a unique conduit for getting the direct-to-consumer advertisement noticed by the end user, because the health reminder could help ensure that, especially over time, the accompanying direct-to-consumer advertisement is regarded better than junk mail. Also, being that end users supply information with regard to the types of health reminders desired, pharmaceutical companies can use such information to target the advertisements to the end user. For example, an end user that requests mammogram reminders (as opposed to prostate exam reminders) may be targeted to receive advertisements for either drugs relating to women, or for drugs that are non-gender specific. Also, in the application process, information provided by the end user, such as an end user's age, can be used for targeted advertising that draws the attention of the end user to products that treat age related maladies, such as osteoporosis. Seasonality could also provide an effective tool, with advertisements for allergy medications accompanying the health reminder during allergy season. Offering health reminders can also be an effective way for a pharmaceutical company to advertise and promote any specific special products or services programs, such as a drug discount program targeted at senior citizens or low-income end users. In addition to pharmaceutical companies, the method lends itself to health product companies, such as companies offering tangible health products such as vitamins or bandages, which are not to be confused with companies offering intangible “health products”, such as “health insurance coverage”. Health insurance coverage, as purchased by or provided for end users, is not intended to apply to this disclosure, because health insurance companies are known to provide health reminders for their subscribers as part of the service, whereas pharmaceutical and health product companies are not known to provide health reminders as an accompaniment to products and/or services advertisement/promotion.

The entity offering health reminders/advertisements also may comprise a third party entity, that offer the service of offering health reminders/advertisements on behalf of another entity, or a plurality of entities, that would like to offer health reminders/advertisements, but do not have the in-house resources to do so. The third party entity may sell advertisement space to go with the health reminders, where the advertisements are from a singular entity; several or numerous entities, where the end result resembles or comprises an ad circular; and where the ad circular may or may not comprise advertising for the providing third party entity. Other possibilities includes where an entity that offers health reminders/advertisements that advertise its own products and services also includes advertisements for associates or subsidiaries, or sells ad space outright while simultaneously offering advertisements for its own products or services.

As suggested earlier, the use of targeted marketing lends itself well to the disclosed method. A third party entity that issues mammogram and OB/GYN reminders to women would use that fact to solicit manufacturers of women's products as advertisers. The method can be adapted to enable the requesting and processing of information that may be used for target marketing purposes. Any additional methods to mine information for the purposes of target marketing may be employed, including information obtained directly from end users, such as where the offering entity prompts the end users for information. Also, any additional information may be used or incorporated for the purposes of target marketing from any outside source, via any communicative embodiment, format, or technology, with an example being an existing data base that contains information on an end user that is accessed using any matching criteria such as name, address, and so on.

The abovementioned special programs is a perfect fit for a drug company that offers a drug discount program, where the drug discount program is highlighted by the end user receiving health related reminders, tips, or suggestions.

The entities offering reminders/advertisements also may comprise third party entities that solely offer the service of offering reminders/advertisements on behalf of entities that would like to offer reminders/advertisements, but do not have the in-house resources to do so. The third party entity may sell advertisement space to go with the reminders, where the advertisements are from a singular entity, or several or numerous entities, where the end result resembles or comprises an ad circular. Other entities offering reminders/advertisements may comprise companies that advertise their products and services, but also include advertisements for associates or subsidiaries, or sells ad space outright while simultaneously offering advertisement for its own products or services.

It should be noted that the use of targeted marketing (marketing that is aimed at a particular individual or demographic) as well as non-targeted marketing lends itself well to the disclosed method. A third party entity that issues mammogram and OB/GYN reminders to women would use that fact to solicit manufacturers of women's products as advertisers. Steps in the method may be adapted to request and process information that may be used for target marketing purposes. Also, any additional methods to mine information for the purposes of target marketing may be employed. Also, any additional information may be used or incorporated for the purposes of target marketing. Such information may also be obtained from or supplied by any outside source, with an example being an existing data base that contains information on an end user that is accessed using any matching criteria such as name, address, and so on.

The disclosed method may make use of any third party or third parties associated with the entity in order to carry out any or all of the method steps that will be disclosed later, where the said third party or third parties may be associated with, retained by, referred by, or linked via Internet or intranet with the entity seen by the end user as the supplier of reminders, tips, or suggestions.

It is prudent that disclaimers regarding reminders, tips, or suggestions should be employed in order to address potential liability issues that could result in the event of missed or otherwise corrupted reminders, tips, or suggestions.

### DETAILED DESCRIPTION OF THE INVENTION

As was illustrated earlier, the health reminder acts as a “non-typical” feature or benefit of “typical” customer services. Those customer services include customer services for any financial services account that may or may not require debt servicing; customer services for any products or services that uses, or may be adapted to use, a sign up or application process; or customer services relating to advertising, where end users actually consent to receiving advertisements. For semantics sake, the method may function to allow either where “typical” customer services comprise the health reminder, or where the health reminder comprises “typical” customer services.

Unlike this method, much of the prior art disregards the obtaining of consent from end users before involving such end users. In the case of customer services where end users receive advertisements, consent is highly unusual being that the bulk of advertisers tend to send advertisements in an unsolicited manner. Also paramount to the method is that the end user has an active, as opposed to passive, relationship with the issuing entity, where the entity actively seeks to obtain end user consent and end user preferences. This method does not rely on exploiting passive end users, and as such works to reduce the indifference that is when dealing with passive end users.

The basic steps of the disclosed method will now be discussed.

To start, an entity providing customer services becomes enabled to provide health reminders, and then makes the customer services additionally comprising the health reminder available to end users. The entity then attracts potential end users of customer services comprising the health reminder using any method of promotion, such as media advertising, mailers, etc. The expectation is to convert potential end users into actual end users by having the end users apply or sign up for customer services, using any embodiment, format or technology for sign-up or application. The concepts and methods of sign-up or application are well known. In this method, the act of applying or signing up reflects the preferences, desires or consent to receive the health reminder.

The health reminder may also be offered to existing end users of customer services as a new feature, preferably where these end users express preferences, desires or consent to receive the health reminder.

Next is the approval step where potential end users of customer services become actual end users of customer services. Here, the level of stringency for “approval” is highly variable, and depends on the type of customer services sought by a given end user. For example, a potential end user seeking customer services such as a home mortgage provides much information and verification, endures a battery of evaluation, and must adequately meet criteria in order to become an end user, whereas a potential end user seeking customer services such as advertising experiences minimal, if any, hurdles in order to become an end user. In any such cases, the receiving of the health reminder by end users is contingent upon potential end users being approved to receive the customer services. It is anticipated that the health reminder will act as an incentive for potential end users to apply or sign up for customer services offering the health reminder.

Next, prompts relating to the health reminder are provided and relayed to the end user; however, the providing and relaying these prompts may occur at any time before, during, or after potential end users of customer services become approved end users. For example, such health related prompts may occur on the initial application for the customer services, may occur after the initial application but before approval takes place (hence the term “during”), or after approval has occurred.

Next, end user data relating to the health reminder is received. While it is envisioned that end user data will rely on responses to the prompts relating to the health reminder, it remains possible that sources other than, or, more likely, in addition to, the end user can be a source of end user data. Such sources include the offering entity, or any third party or third parties. The receiving of end user data may occur at any time before, during, or after potential end users of customer services become approved end users. End user data relating to the health reminder is stored on a computer readable medium.

Next, the end user performs activity relating to the business of the account that is served by customer services, such as transactions, consumption of products and/or services, etc., resulting in customer services end user data. The customer services end user data is stored on a computer readable medium.

Next, the health reminder is provided to the end user based on the prompts relating to the health reminder and end user data relating to the health reminder, and the customer services communications are provided to end users based on customer services end user data.

Additional discussion and clarification will now follow.

Once end users have specified an interest in receiving health reminders, the entity provides health related prompts to end-users. This may be done using any communicative embodiment, format or technology, such as a printed application or questionnaire, an online application or questionnaire, through use of a call center with live or computerized means of gathering information, or, for argument's sake, even carrier pidgin. Prompts may serve any purpose, such as to enable the end user to specify basic end user information, such as name, address, date of birth, etc., or to specify end user preferences information such as what type of reminders to receive, when to receive a given reminder, how far in advance to receive warning reminders, or even the capability to customize or tailor any or all aspects of the reminders, tips, or suggestions comprising parameters, content, text, etc.

Any chosen communicative embodiment, format or technology may make use of and relay its own format, means, or embodiment of prompts, where the prompts comprise specific headings questions, information, or guidelines that enable the end user to supply what will become end user data. In the preferred embodiment, prompts primarily comprise specific headings, questions, information, or guidelines that have health related topicalities for use in providing health related reminders, tips, or suggestions.

Prompts relating to the health reminder are extraordinarily important. In this disclosure, the totality of health related prompts relating to the health reminder comprise the addressing of health related matters of end users. Here, the intended purpose of the prompts relating to the health reminder is to raise end users' awareness of health related issues pertinent to the end users. For example, a prompt that reads: “What month would you like to be reminded to have your mammogram?” helps raise a woman's awareness that she needs to have an annual mammogram. Even if the woman vaguely has it in the back of her mind that having a mammogram is prudent, actually having the question appear before her reinforces to her the importance of the mammogram, and converts a vague notion into something that should be considered seriously and that should be immediately acted upon. Here, the prompts, as well as the actual health reminder, work as health awareness tools to assist the woman to act towards her own welfare.

Additionally, prompts may comprise specific headings, questions, information, or guidelines that have non-health related topicalities, comprising reminders such as birthday reminders, car care reminders, etc., for use in providing non-health related reminders, tips, or suggestions in addition to the health related reminders, tips, or suggestions.

Although not as crucial to the method as prompts relating to the health reminder, prompts relating to customer services are mentioned here for the first time, and may additionally be employed. These prompts relating to customer services may comprise requests for any additional information that may be used for target marketing purposes, such as demographic information, or viewpoints and preferences that are but can be not specifically related to the health reminder. Such information may also comprise information that enables end users to choose the advertisements that they wish to receive with regards to products, services or subjects they are interested in. Finally, prompts may comprise requests for any information whose purpose, function, or relevance may or may not be readily apparent, such as a mother's maiden name, the names of pets, favorite planets, requests for information relating to customer preferences, etc. While this “any information” most likely won't have any function with regard to the health reminder, it remains possible for “any information” to have minimal, some, or even considerable function with regard to the health reminder. The information obtained from these specific customer services prompts becomes part of the customer services data. It should be noted that these end user prompts go beyond basic end user information, such as name, address, etc., and it is possible to use the method with or without these specific customer services prompts. Customer services prompts, as with prompts relating to the health reminder, may comprise any communicative embodiment, format or technology.

Any of the abovementioned prompts may be added, modified, revised, or deleted. Furthermore, the prompts may be added, modified, revised, or deleted by any party or parties deemed desirable, whether it is the offering entity or entities, associated third party or parties, or end users, using any communicative embodiment, format or technology. For example, in an online application or questionnaire, an end-user may choose to delete prompts that do not apply to him or her, or the issuer of the reminder may choose to expand the health reminders to be offered, and add prompts accordingly. Likewise, an associated third party may deem that, using recent medical findings, the existing guidelines regarding when to have a given exam show evidence that modification to the guidelines is prudent, and therefore adjustments may be made to the relevant prompt. The phrase “by any party or parties deemed desirable” may be clarified through example. The entity offering the customer services and health reminder may deem that it is desirable for end users to delete non-relevant prompts, or the entity may deem it undesirable for the end user to have such capabilities; likewise, the offering entity can make similar determinations on whether an associated third party may make modifications to the prompts, or to what extent such modifications can be made.

The information that is supplied by the end user in response to prompts relating to the health reminder, or to prompts relating to the health reminders, tips, or suggestions and non-heath reminders, tips, or suggestions comprising the health reminder, is end user data relating to the health reminder. End user data relating to the health reminder may comprise any information, such as: basic end user information comprising information such as name, address, gender, age, etc.; or end user preference information comprising information relating to the health reminder, such as the types of health reminders desired, text that the end user has supplied that will come up as a reminder, when a particular reminder will occur, how much time in advance will a reminder begin to show, the duration of appearance for a given reminder, etc. Such end user data relating to the health reminder will be used to tailor the health reminder to the end user.

Customer services end user data comprises a rather broad category, and can be clarified using two sub-categories. The first is where customer services end user data comprises any data pertinent to the activity or business of the account, such as account activity data, billing data, consumption or usage summaries, receipts pertaining to transactions, etc. The second is where customer services end user data comprises any other data not relating to activity, consumption, or transactions. Myriad uses for such “any other data” include any information used for target marketing purposes comprising information such as whether the end user has pets to assist targeting pet owners, whether the end user likes to travel to assist targeting travelers, etc.; any information relating to customer preferences; or, any information whose purpose, function, or relevance may or may not be readily apparent, comprising information such as the abovementioned mother's maiden name, names of pets, favorite planets, etc. Customer services end user data may also comprise any information obtained internally or externally from any external source, such as a third party or third parties, for information such as credit ratings or credit scores. While customer services end user data comprising “any information” most likely won't have any function with regard to the health reminder, it remains possible for “any information” to have minimal, some, or even considerable function with regard to the health reminder.

End user data relating to the health reminder and/or customer services may be relayed via any communicative embodiment, format or technology. End user data relating to the health reminder and/or customer services may also be added, modified, revised, or deleted. Moreover, end user data may be added, modified, revised, or deleted by any party or parties deemed desirable, whether it is the offering entity or entities, associated third party or parties, or end users, using any communicative embodiment, format or technology. For example, an end user may want an address change, or for a mammogram reminder to occur at a different time, or for an additional reminder to be added, such as an annual prostate exam reminder for a husband turning forty years of age, or a non-health related reminder pertaining to birthdays for a new grandchild. The offering entity may wish to delete the end user data on a deceased end user. With regard to “any party or parties deemed desirable”, in many (but not necessarily all) cases, the issuing entity will determine which parties are “deemed desirable” to make changes, as well as which changes may be made. An issuing entity, for example, could allow an end user to have unrestricted access to make changes to end user data relating to the health reminder via a customer service representative. As an additional note, the issuing entity may offer such an end user data change for free, or may charge a fee to all end users, or may charge a fee only to end users that make excessive changes. For whatever reason or purpose, having the ability to change or otherwise edit end user data is useful.

Using the information that has been generated through the use of health related prompts and health related end user data, the issuing entity will provide health reminders comprising one or more reminders, tips, or suggestions to the end user. The health reminder may comprise any periodicity for distribution, and may also coincide with the desired disbursement of customer services communications, such as monthly activity statements or bills, monthly advertising distributions, etc. For disclosures sake, the health reminder may also be disbursed per any event, such as the end user's birthday, in coordination with a transaction that has occurred, or due to other activity not directly related to the health reminder per se; also, the health reminder may be disbursed on any non-periodic and/or random basis.

The resulting health reminder comprising reminders, tips or suggestions may comprise many characteristics. The first is where the reminders, tips or suggestions comprise automatic reminders, tips or suggestions. Such would be a reminder to wear sunscreen during summer to guard against skin cancer, which is a reminder that can benefit everybody.

Next is where the health reminder comprising reminders, tips, or suggestions comprise basic end user information to tailor the reminders, tips, or suggestions to the end user, with examples being a colorectal examination reminder that occurs automatically on the end user's fiftieth birthday by using the basic end user information of the date of birth to trigger the reminder; sending breast self-exam reminders using basic end user information that the end user is female; or even addressing the end user by name in the form of a friendly greeting that accompanies the health reminder.

Finally is where the health reminder comprising reminders, tips, or suggestions comprise end user preferences information, where end user preferences information comprises the ability to enable the end user to select, customize, tailor, or supply any or all aspects of the reminders, tips, or suggestions comprising parameters, content, text, etc., where the end results comprises the preferences or desires of the end user. Here, the reminders, tips, or suggestions reflect any extent of input as a result of the earlier mentioned prompts and end user data, where the resulting reminder, tips, or suggestions comprise any desired characteristics, such as when the reminder, tip, or suggestion is generated; the duration of the appearance of same; or even special text content submitted by the end user, or for that matter, any of the associated parties.

It should be noted that the health reminder comprising reminders, tips, or suggestions may comprise any permutation or combination of the following: reminders, tips, or suggestions that are automatic, general, or non-end user specific in nature; reminders, tips, or suggestions that comprise basic end user information to tailor the reminders, tips, or suggestions to the end user; and/or reminders, tips, or suggestions that comprise end user preferences information, where end user information comprises the ability to enable the end user to select, customize, tailor, or supply any or all aspects of the reminders, tips, or suggestions comprising parameters, content, text, etc, where the end results comprise the preferences or desires of the end user.

Furthermore, the reminders, tips, or suggestions may comprise health related topicalities only, or both health-related and non-health related topicalities. Also, the health reminder may comprise information provided by the following entities, in addition to the end user, either singularly, or plurally in any combination or permutation: the entity offering and/or providing the health reminder, or a third party entity or third party entities that may or may not comprise entities in a health related field. For example, it would be prudent for the health reminder to make use of information from a health related government agency such as the Center for Disease Control, or the National Cancer Institute. Such information may be relayed using any communicative embodiment, format or technology. Additionally, any or all prompts pertaining to the health reminder and/or any or all end user data pertaining to the health reminder may make use of such information.

Finally, the health reminder may be relayed using any communicative embodiment, format or technology, and may comprise any communicative embodiment, format or technology, such as where the health reminder is relayed by a phone call from a call center, faxed, mailed, e-mailed, accessed from a website using a password, etc. The communicative embodiment, format or technology for the health reminder may be selected by anybody deemed desirable, such as the issuing entity or entities, associated third party or parties, or even by allowing an end user to make a choice from a list of options.

As with the health reminder, customer services communications may be relayed using any communicative embodiment, format or technology, and may comprise any communicative embodiment, format or technology. Once again, the communicative embodiment, format or technology may be selected by anybody deemed desirable, such as the issuing entity or entities, associated third party or parties, or possibly even by end users.

Numerous scenarios regarding how the end user receives the health reminder and the customer services communications may be employed. The health reminder can appear directly on the customer services communications. Practical embodiments include, but are not limited to, mailings, faxes, and e-mails. In the case of mailings, the health reminder may be detachable from the customer services communications by a perforation, or by any other means that allows for separation, that allows the health reminder to be removed from the customer services communications. Such could also apply to e-mail, where separation results by cutting and pasting the health reminder. Health reminders do not have to appear directly on the customer services communications, but can comprise separate items in the customer services communications enclosure, such as in the same envelope in a mailing, or as a file attachment on e-mail. Finally, the health reminder may be sent to the end user independently of the customer services communications or customer services communication enclosures.

Any party or parties deemed desirable may select the communicative embodiment, format or technology of the health reminder and/or customer services communications. For example, the issuing entity, or third party actually sending the health reminder and/or customer services communications may select to send only e-mail, or may offer an end user a menu of choices that enables the end user to select the communicative embodiment, format or technology.

The health reminder and the customer services communications may comprise identical, similar or different communicative embodiments, formats or technologies, with an example having the health reminder being e-mailed while the customer services communications are mailed. One may surmise that probably the most desirable embodiment would have the health reminder being attached to the customer services communications; however, other embodiments are disclosed as a means of illustrating the inherent flexibility of the disclosure. Also, the health reminder and/or the customer services communications, either combined, separately, or both, may be relayed in a plurality of communications using identical, similar, or different communicative embodiments, formats or technologies. For example, a printed health reminder may be mailed, while a backup copy may be e-mailed.

Also, the plurality of communications comprising the health reminder and/or the customer services communications, either combined, separately, or both, that are relayed using identical, similar, or different communicative embodiments, formats or technologies, may comprise any combination or permutation of identical, similar, or different content. As an example, the conjoined health reminder and customer services communications may be mailed, while the health reminder (sans customer services communications) are also e-mailed; or, where additional customer services communications, comprising differing content from the customer services communications mailed with the health reminder, are faxed or e-mailed.

The disclosed method may make use of any third party or third parties associated with the entity in order to carry out any or all of the method steps, where the said third party or third parties may be associated with, retained by, referred by, or linked via Internet or intranet with the entity seen by the end user as the supplier of reminders, tips, or suggestions.

An additional method step that is optional is where the end user acknowledges receipt or the health reminder and/or customer services communications. Such may be done employing any communicative embodiment, format or technology.

Also, it is prudent that disclaimers regarding reminders, tips, or suggestions should be employed in order to address potential liability issues that could result in the event of missed or otherwise corrupted reminders, tips, or suggestions.

Method claims are also presented with corresponding system claims. Apparatus claims for a health reminder combined with advertisements are also presented.

Given the many variations with regards to means, embodiments, and topicality, it is possible for the disclosure to be practiced in myriad ways. It is anticipated by the Applicant that the full potential, spirit and scope of the disclosure, as well as its equivalents, will be apparent to those skilled in the art.

Before the method steps are explained, an overview of the method's components is in order. The requesting by the end user to receive the health awareness tools comprising health related reminders, tips, or suggestions comprises the use of one or more applications. A given application may allow the end user to sign up for advertisements and health related reminders, tips, or suggestions together; or, an application may refer to another application, such as where an advertisement application has a link or reference to a questionnaire or application comprising where the end user provides any kinds of information that enables the end user to express preferences, where such a questionnaire or application comprises prompts that will be discussed later. Also, an application for a health reminder could include providing advertising to the end user as well. The Applicant considers the combining of an application (whether for advertisements, or even financial cards) with health related prompts, or an application that links or references an additional health related questionnaire or application to be novel with regard to the prior art, and novel in that there is no ordinary motivation to combine the two. The completion of the application or applications comprises (assuming acceptance of the completed application or applications) the opening of an end user “account.”

The health related prompts (as separated from prompts used for purposes other that health) and resulting health related end user data that will be discussed later comprise a health reminder file. End user accounts not primarily related to medical care (such as for financial card accounts, to receive advertising, etc.) have heretofore never comprised the use of a health reminder file, which the Applicant considers to be novel. The term “not primarily related” is included to clarify that a credit card account that is used to pay a doctor bill or other medical expense is “not primarily related” to medical care. An example of an account that is primarily related to medical care is an end user's account with a medical insurance provider whose system could very well incorporate the use of a health reminder file. Non-health related reminders may have a separate file from the health reminder file, or may comprise part of the health reminder file. In a bow to semantics, a non-health related reminder file that comprises any number of non-health related reminders, and additionally comprises any of the following, either singularly, or in any combination or permutation: one or more health related prompts; one or more bits of health related end user data; or, one or more health related reminders; is deemed for the purposes of distinction and clarification to be a health reminder file. Again, there is no ordinary motivation to combine the use of a health reminder file with an end user account that is not primarily related to medical care. In the rare instance of stand-alone prompts and/or stand-alone end user data, a determination with regards to bearing on this disclosure may be had by checking whether the prompts and/or end user data is used to facilitate any health related reminders, tips, or suggestions.

By end users signing up to receive health related reminders, tips, or suggestions, and advertising, they are in fact requesting or giving consent to receive them. This consent step is unusual being that advertisers tend to send advertisements without first asking permission. Much of the prior art also disregards the obtaining of consent from end users. Also paramount to the method is that the end user has an actual relationship with the issuing entity, where the entity seeks end user preferences directly from the end user, which is another thing that many methods do not comprise.

The steps of the disclosed method will now be discussed. Once end users have specified an interest in receiving health reminders, tips, or suggestions, the first step is for the supplying entity to provide prompts to end-users. This may be done using any communicative means or embodiment, such as a printed application or questionnaire, an online application or questionnaire, or through use of a call center with live or computerized means of gathering information. As discussed earlier, one or more applications or questionnaires may be used. Any chosen communicative means or embodiment may make use of and relay its own format of prompts, where the prompts comprise specific headings questions, information, or guidelines that enable the end user to supply what will become end user data. In the preferred embodiment, prompts comprise specific headings, questions, information, or guidelines that have health related topicalities for use in providing health related reminders, tips, or suggestions. Additionally, prompts may comprise specific headings, questions, information, or guidelines that have non-health related topicalities (comprising reminders such as birthday reminders, car care reminders, etc.) for use in providing non-health related reminders, tips, or suggestions in addition to the health related reminders, tips, or suggestions. Prompts may also comprise requests for any information that may be used for target marketing purposes, such as demographic information, or viewpoints and preferences not specifically related to the reminders, tips or suggestions. Such information may also comprise information that enables end users to choose the advertisements that they wish to receive with regards to products, services or subjects they are interested in. Finally, prompts may comprise requests for any other information whose purpose, function, or relevance may or may not be readily apparent, such as a mother's maiden name, the names of pets, favorite planets, etc.

Prompts may serve any purpose, such as to enable the end user to specify basic end user information (as in name, address, date of birth, etc.) or to specify cardholder preferences information (what type of reminders to receive, when to receive a given reminder, how far in advance to receive warning reminders, or even the capability to customize or tailor any or all aspects of the reminders, tips, or suggestions comprising parameters, content, text, etc.).

Prompts may also be added, modified, revised, or deleted. Furthermore, the prompts may be added, modified, revised, or deleted by any party or parties deemed desirable, whether it is the offering entity or entities, associated third party or parties, or end users. For example, on an online application or questionnaire, an end-user may choose to delete prompts that do not apply to him or her. Likewise, an associated third party may deem, using recent medical findings, that the existing guidelines regarding when to have a given exam show evidence that modification to the guidelines is prudent, and therefore can adjust accordingly.

The information that is supplied by the end user in response to the prompts is end user data, which is then stored on a computer readable medium. End user data comprises all manners of information, such as: basic end user information (comprising information such as name, address, gender, age, etc.); end user preference information (comprising information such as the types of health reminders desired, text that the end user has supplied that will come up as a reminder, when a particular reminder will occur, how much time in advance will a reminder begin to show, the duration of appearance for a given reminder, etc.); end user information that may be used for target marketing purposes (comprising information such as whether the end user has pets, likes to travel, etc.); and any other end user information whose purpose, function, or relevance may or may not be readily apparent, (comprising information such as the abovementioned mother's maiden name, names of pets, favorite planets, etc.).

End user data may also be added, modified, revised, or deleted. Moreover, end user data may be added, modified, revised, or deleted by any party or parties deemed desirable, whether it is the offering entity or entities, associated third party or parties, or end users. For example, an end user may want an address change, or for a mammogram reminder to occur at a different time, or for additional reminders to be added (like a non-health related birthday reminder for a new grandchild). The offering entity may wish to delete the end user data on a deceased end user. For whatever reason, having the ability to change or otherwise edit end user data is useful. Finally, end user data may be relayed via any communicative means or embodiment. An end user may call a customer service representative to confirm when a mammogram reminder will occur, or to make any desired changes. Likewise, end user data may be relayed easily (in order to affect additions, modifications, revisions, or deletions) over the Internet.

Using the information that has been generated through the use of prompts and varied forms of end user data, the issuing entity will provide one or more reminders, tips, or suggestions to the end user. The resulting reminders, tips or suggestions may comprise many characteristics. The first is where the reminders, tips or suggestions comprise automatic reminders, tips or suggestions. Such would be a reminder to wear sunscreen during summer to guard against skin cancer, which is a reminder that can benefit everybody.

Next is where the reminders, tips, or suggestions comprise basic end user information to tailor the reminders, tips, or suggestions to the end user, with examples being a colorectal examination reminder that occurs automatically on the end user's fiftieth birthday by using the basic end user date of birth information to trigger the reminder; sending breast self-exam reminders using basic end user information that the end user is female; or even addressing the end user by name in the form of a friendly greeting that accompanies the reminders, tips, or suggestions.

Finally is where the reminders, tips, or suggestions comprise end user preferences information, where end user preferences information comprises the ability to enable the end user to select, customize, tailor, or supply any or all aspects of the reminders, tips, or suggestions comprising parameters, content, text, etc., where the end results comprises the preferences or desires of the end user. Here, the reminders, tips, or suggestions reflect any extent of input as a result of the earlier mentioned prompts and end user data, where the resulting reminder, tips, or suggestions comprise any desired characteristics, such as when the reminder, tip, or suggestion is generated; the duration of the appearance of same; or even special text content submitted by the end user (or any of the associated parties, for that matter).

It should be noted that the reminders, tips, or suggestions may comprise any permutation or combination of the following: reminders, tips, or suggestions that are automatic, general, or non-end user specific in nature; reminders, tips, or suggestions that comprise basic end user information to tailor the reminders, tips, or suggestions to the end user; and/or reminders, tips, or suggestions that comprise end user preferences information, where end user information comprises the ability to enable the end user to select, customize, tailor, or supply any or all aspects of the reminders, tips, or suggestions comprising parameters, content, text, etc, where the end results comprise the preferences or desires of the end user. Furthermore, the reminders, tips, or suggestions may comprise health related topicalities only, or both health-related and non-health related topicalities. Finally, reminders, tips, or suggestions may be relayed using and comprising any communicative means or embodiment, whether said reminders, tips, or suggestions are relayed by a phone call from a call center, faxed, mailed, e-mailed, accessed from a website using a password, etc. The communicative means or embodiment may be selected by anybody deemed desirable, such as the issuing entity or entities, associated third party or parties, or by possibly even allowing end users to make a choice.

In discussing advertisements, it was disclosed earlier that the advertisements per the disclosure may be targeted to a particular individual or demographic, or may be non-targeted. As with reminders, tips, or suggestions, advertisements may comprise any communicative means or embodiment, although some (like mailings or e-mails) are more practical than others (such as advertisements via carrier pigeon). Once again, the communicative means or embodiment may be selected by anybody deemed desirable, such as the issuing entity or entities, associated third party or parties, or by possibly even allowing end users to choose.

Numerous scenarios regarding how the end user receives reminders, tips, or suggestions and the advertisements may be employed. The reminders, tips, or suggestions can appear directly on the advertisements. This is especially novel being that, once yet again, there is no ordinary motivation to combine the two. Practical embodiments include (but are not limited to) mailings, faxes, and e-mails. In the case of mailings, the reminders, tips, or suggestions may be detachable from the advertisements by a perforation, or by any other means that allows for separation, that allows the reminders, tips, or suggestions to be removed from the advertisements. Such could also apply to e-mail, where separation results by cutting and pasting the reminders, tips, or suggestions. Reminders, tips, or suggestions do not have to be directly on the advertisements, but may comprise separate items in the advertisement enclosure (in the same envelope in a mailing, or as a file attachment on e-mail). Finally, reminders, tips, or suggestions may be sent to the end user independently of the advertisements or advertisement enclosures.

The reminders, tips, or suggestions and the advertisements may comprise identical, similar or different communicative means or embodiments, with an example having the reminders, tips, or suggestions being e-mailed while the advertisements are mailed. One may surmise that probably the most desirable embodiment would have the reminders, tips, or suggestions being attached to the advertisements; however, other embodiments are disclosed as a means of illustrating the inherent flexibility of the disclosure. Also, the reminders, tips, or suggestions and/or the advertisements either combined, separately, or both, may be relayed in a plurality of communications using identical, similar, or different communicative embodiments. For example, a printed set of reminders, tips or suggestions may be mailed, while a backup copy may be e-mailed.

Also, the plurality of communications comprising reminders, tips, or suggestions and/or the advertisements, either combined, separately, or both, that are relayed using identical, similar, or different communicative embodiments, may comprise any combination or permutation of identical, similar, or different content. As an example, the conjoined reminders, tips, or suggestions and advertisements may be mailed, while the reminders, tips, or suggestions (sans advertisements) are also e-mailed; or, where additional advertisements with differing content from the advertisements mailed with the reminders, tips, or suggestions, are faxed or e-mailed.

An additional method step that is optional is where the end user acknowledges receipt or the reminders, tips, or suggestions and/or advertising. Such may be done employing any communicative means, embodiment, or format.

The advertisements that are used in coordination with the reminders, tips, or suggestions may also be used in association with account statements, transaction statements or billing statements that are also used in coordination with reminders, tips, or suggestions per the parent application. One must take special note that account, transaction, or billing statements with advertising alone may lack inherent novelty; therefore, what is being disclosed is account, transaction, or billing statements in conjunction with advertisements that are also in conjunction with reminders, tips, or suggestions, with the same flexibility that is disclosed in the parent application, and earlier in this application as well.

Given the many variations with regards to means, embodiments, and topicality, it is possible for the disclosure to be practiced in myriad ways. It is anticipated by the Applicant that the full potential, spirit and scope of the disclosure, as well as its equivalents, will be apparent to those skilled in the art.

1. A method for providing a health reminder for current or potential end users of products or services of a product or service provider that does not provide health related products or services, comprising:
(a) providing said health reminder to said current or potential end users,
wherein said product or service provider does not provide products or services related to the health care of individuals, or wherein said service provider does not provide products or services related to the dissemination of health information to individuals.

2. The method of claim 1, further comprising
(b) also providing to said current or potential end users at least one advertisement for one or more products or services of said product or service provider.

3. A method for a pharmaceutical company to offer and provide health reminders for potential and current end users that do not relate to specific pharmaceutical products of said company, comprising
(a) providing said health reminder to one or more of said end users,
wherein said health reminder does not specifically relate to said pharmaceutical products that said potential or current end users would potentially or do receive from said pharmaceutical company.

4. The method of claim 3, further comprising
(b) also providing to said current or potential end users direct-to-consumer advertisement for one or more products of said pharmaceutical company.

5. A method for providing a health reminder for potential or current end users of products or services by a product or service provider, comprising:
(a) providing by said service provider of said related health reminder to said potential or current end users,
wherein said health reminder does not relate to a specific product or service of said product or service provider.

6. The method of claim 5, further comprising
(b) also providing to said current or potential end user a direct-to-consumer advertisement for one or more products of said product or service provider.

7. A method according to claim 1, wherein said health reminder is selected from a health-related topic, a health-related preventive measure, a medical check-up, a medical examination, a medical procedure.

8. A method according to claim 1, wherein said method further provides a step wherein said end user can apply for said service or purchase said product.

9. A method according to claim 1, wherein said method further provides a step wherein said end user provides additional information to said product or service provider to customize the types of health reminders that said end user receives.

10. A method according to claim 1, wherein said product or service includes a financial card or financial service.

11. The method of claim 2, wherein advertisement comprises one or more of an entity promotion, product promotion, services promotion, sales event promotion, special offers promotion, promotion using coupons, promotion of special programs, or promotion comprising information dissemination.

12. A method of claim 1, wherein a third party provides said health reminder on behalf of said product or service provider.

13. A method of claim 1, wherein said health reminder further comprises medical or legal disclaimers.

14. A method of claim 1, wherein said health reminder comprises one or more reminders, tips, or suggestions to be specific to said end user and/or individuals related to or otherwise associated with said end user with regards to any health-related topic, health-related preventive measure, medical check-up, medical examination, or medical procedure.

15. A method according to claim 1, wherein aid health reminder comprises a health awareness tool that is not used to remind said end user of a preexisting or already scheduled doctor appointment.

16. A method according to claim 1, wherein said health reminder comprises a health awareness tool to encourage said end user to self-schedule a medical check-up, medical examination, and/or medical procedure in absence of any direct prompting from the doctors or health care professionals of said end user.

17. A method according to claim 2, wherein said end user actively gives consent to receiving said advertisement or said health reminder.

18. A method according to claim 2, wherein said advertisement comprises advertisement for products and/or services that have no primary correlation to the health care or health management of said end user.
